(19) United States
(12) Patent Application Publication
(10) Pub. No.: US 2025/0168138 A1
(43) Pub. Date: May 22, 2025

(54) METHOD FOR PROCESSING INFORMATION, DEVICE, AND MEDIUM

(71) Applicant: Beijing Zitiao Network Technology Co., Ltd., Beijing (CN)

(72) Inventors: Zhenyu ZHAO, Beijing (CN); Haitao JIA, Beijing (CN); Changsheng WANG, Beijing (CN); Yizhe YANG, Beijing (CN); Liuyuan YU, Beijing (CN); Jiahe MA, Beijing (CN)

(21) Appl. No.: 18/953,565

(22) Filed: Nov. 20, 2024

(30) Foreign Application Priority Data
Nov. 21, 2023 (CN) 202311562594.0

(51) Int. Cl. H04L 51/18; H04L 51/02

(52) U.S. Cl. CPC H04L 51/18; H04L 51/02

(57) ABSTRACT

The present disclosure provides a method for processing information, device, and medium that are applied to a server of a digital assistant. The method includes: receiving a first request associated with a first task subject sent by a client of the digital assistant; determining metainformation of the first task subject according to the first request, wherein the metainformation of the first task subject is stored in the server of the digital assistant; and processing the first request according to the metainformation of the first task subject. In embodiments of the present disclosure, the server of the digital assistant can support task subject-related functions to realize the scene-based application of the digital assistant and further expand the application scene of the digital assistant.

### CROSS-REFERENCE TO RELATED APPLICATION

The present application claims the priority and benefits of Chinese Patent Application No. 202311562594.0, filed on Nov. 21, 2023, which is incorporated herein by reference in its entirety as part of the present application.

### TECHNICAL FIELD

Embodiments of the present disclosure relate to a method for processing information method, an electronic device, and a computer readable storage medium.

### BACKGROUND

With the rapid development of computer technologies, digital assistants have emerged. These digital assistants are usually capable of natural language processing, making it possible for users to interact with them through human-computer dialogues.

Specifically, a user can send request information through the client of a digital assistant, and the server of the digital assistant processes the request information to generate a reply message and then returns the reply information to the client of the digital assistant, thereby realizing human-computer dialogues.

However, it is difficult for most users to proactively explore the abundant application scenes of digital assistants, and how to enrich the user's experience of using the digital assistant has become an urgent problem to be solved.

### SUMMARY

The present disclosure provides a method and a system for processing information method, an electronic device, a computer readable storage medium, and a computer program product.

Embodiments of the present disclosure provide a method for processing information, applied to a server of a digital assistant, and the method includes:
receiving a first request associated with a first task subject sent by a client of the digital assistant;
determining metainformation of the first task subject according to the first request, wherein the metainformation of the first task subject is stored in the server of the digital assistant; and
processing the first request according to the metainformation of the first task subject.

Embodiments of the present disclosure provide a system for processing information, and the system includes:
a communicating module, configured to receive a first request associated with a first task subject sent by a client of a digital assistant;
a determining module, configured to determine metainformation of the first task subject according to the first request, wherein the metainformation of the first task subject is stored in a server of the digital assistant; and
a processing module, configured to process the first request according to the metainformation of the first task subject.

Embodiments of the present disclosure provide an electronic device that includes a processor and a memory. The processor and the memory are communicated with each other. The processor is configured to execute instructions stored in the memory such that the electronic device executes the method for processing information in any of the above implementations.

Embodiments of the present disclosure provide a computer readable storage medium having instructions stored therein. The instructions instruct the electronic device to execute the method for processing information according to any of the above implementations.

Embodiments of the present disclosure provide a computer program product containing instructions. The computer program product, when being run on an electronic device, causes the electronic device to execute the method for processing information according to any of the above implementations.

The present disclosure may be further combined to provide additional implementations based on the implementations provided above.

### BRIEF DESCRIPTION OF DRAWINGS

To illustrate the technical method of the embodiment of the present disclosure more clearly, the drawings that are required to be used in the embodiments are briefly described below.

FIG. 1 is a schematic architecture diagram of a system for processing information according to the embodiment of the present disclosure;

FIG. 2 is a schematic flowchart of a method for processing information according to the embodiment of the present disclosure;

FIG. 3 is a schematic flowchart of creating a task subject according to the embodiment of the present disclosure;

FIG. 4 is a schematic flowchart of editing a task subject according to the embodiment of the present disclosure;

FIG. 5 is a schematic flowchart of disabling a task subject according to the embodiment of the present disclosure;

FIG. 6 is a schematic flowchart of starting a new session according to the embodiment of the present disclosure;

FIG. 7 is a schematic flowchart of sharing a task subject according to the embodiment of the present disclosure;

FIG. 8 is a schematic flowchart of joining a task subject according to the embodiment of the present disclosure;

FIG. 9 is a schematic flowchart of a human-computer dialogue according to the embodiment of the present disclosure;

FIG. 10 is a schematic flowchart of a human-computer dialogue according to the embodiment of the present disclosure;

FIG. 11 is a schematic structure diagram of a system for processing information according to the embodiment of the present disclosure; and

FIG. 12 is a schematic structure diagram of an electronic device according to the embodiment of the present disclosure.

### DETAILED DESCRIPTION

The terms “first” and “second” in the embodiments of the present disclosure are used for descriptive purposes only and should not be construed as indicating or implying relative importance or implicitly indicating the number of technical features indicated. Thus, defining the “first” and “second” features may explicitly or implicitly include one or more of these features.

First, some technical terms involved in the embodiments of the present disclosure are introduced.

Digital assistants, also known as dialogue robots or chatbots, usually have natural language processing capabilities, and users can interact with them through human-computer dialogues.

In this disclosure, the concept “task subject” has been proposed. Task subject, also known as dialogue scene, may be understood as the subject of a human-computer dialogue between a user and a digital assistant. Given that it is difficult for most users to proactively explore the abundant application scenes of digital assistants, digital assistants can provide users with targeted guidance. For example, when a user needs to perform tasks in different scenes by means of digital assistants, the user often needs to interact with different digital assistants (that is, each digital assistant is only used to perform the tasks in one scene), making it impossible to save information in one place, and these multiple digital assistants cannot share information, which reduces the flexibility of the interactive function in digital assistants.

Therefore, digital assistants can support users to make human-computer dialogues for specific scenes. For example, digital assistants can support users to select a task subject according to their actual needs and start dialogues under this task subject (also known as starting scene dialogues).

One task subject is configured with corresponding configuration information in order to execute a task of a corresponding type, and the configuration information may include at least one selected from the group consisting of: task subject setting information, and plug-in information, wherein the task subject setting information is used to describe information related to the corresponding task subject, and the plug-in information indicates at least one plug-in that is used to execute the task under the corresponding task subject.

In some embodiments, the task subject setting information may be used to construct a prompt, in order to provide the prompt to a language model used under the corresponding task subject, and at this moment, reply information for the user may be determined based on an output from the language model. The task subject setting information may include at least one selected from the group consisting of: description of the task of the corresponding type, reply style of the digital assistant under the corresponding task subject, definition of workflow to be executed under the corresponding task subject, or definition of reply format of the digital assistant under the corresponding task subject.

In some other embodiments, in addition to the task subject setting information and the plug-in information, the configuration information of one task subject may further include at least one selected from the group consisting of: indication of a selected language model, wherein this language model is called to determine a reply to the user under the corresponding task subject; task subject guidance information, wherein the task subject guidance information is presented to the user after the corresponding task subject is selected; and at least one recommended question for the digital assistant, wherein after the corresponding task subject is selected, at least one recommended question is presented to, and thus selectable by, the user.

In response to reception of a selecting operation for a first task subject in at least one task subject, interaction between the user and the digital assistant may be performed on an interaction page of the user and the digital assistant based on the configuration information of the first task subject, thus realizing selection for the task subject (also known as scene selection).

The processing of the digital assistant may different for the dialogues started by the user under different task subjects. Specifically, prompts in the language model utilized by the digital assistant may different for the dialogues started by the user under different task subjects, and the prompt may include descriptive information related to the task subject. For example, when the task subject is a “schedule subject”, the prompt may include descriptive information related to schedules (such as function descriptive information, parameter descriptive information related to schedules, etc.).

In addition, processing tools that are called by the digital assistant may also differ for the dialogues started by the user under different task subjects, and the processing tools may include tools related to the task subjects. For example, when the task subject is a “schedule subject”, the processing tool called by the digital assistant may be a schedule plug-in. For another example, when the task subject is a “document subject”, the processing tool called by the digital assistant may be a document plug-in.

After the user selects the first task subject, the first task subject may be turned on in the interaction page of the digital assistant. For example, the interaction page may present a dividing line between the first task subject and a previous task subject, and then present an identity of the first task subject at an area associated with the dividing line, in response to the interaction between the user and the digital assistant being performed in the first task subject, as a result of which different task subjects (also known as different scenes) can be distinguished.

For example, before starting dialogues with the digital assistant, the user needs to select the processing tool (i.e., plug-in) by himself/herself. However, the above method requires the user to have a certain knowledge of different plug-ins, and therefore is extremely error-prone. In the dialogues under the task subject, the plug-in information is configured in the task subject, which lowers the threshold for the user to use the digital assistant and simplifies user operations.

However, how to implement a series of functions of the scene dialogues in the digital assistant has become an urgent problem to be solved.

In view of this, the present disclosure provides a method for processing information. The method is applied to a server of a digital assistant. The server of the digital assistant receives a first request associated with a first task subject sent by a client of the digital assistant, and determines metainformation of the first task subject according to the first request, wherein the metainformation of the first task subject is stored in the server of the digital assistant. Then, the server of the digital assistant processes the first request according to the metainformation of the first task subject.

In this method, by storing the metainformation of the task subject in the server of the digital assistant, the server of the digital assistant is able to utilize the metainformation of the task subject to perform request processing when receiving a request associated with the task subject. As such, the server of the digital assistant can support task subject-related functions to realize the scene-based application of the digital assistant and further expand the application scene of the digital assistant.

For a better understanding of the technical solution provided in the embodiment of the present disclosure, a description will be given below in conjunction with the accompanying drawings.

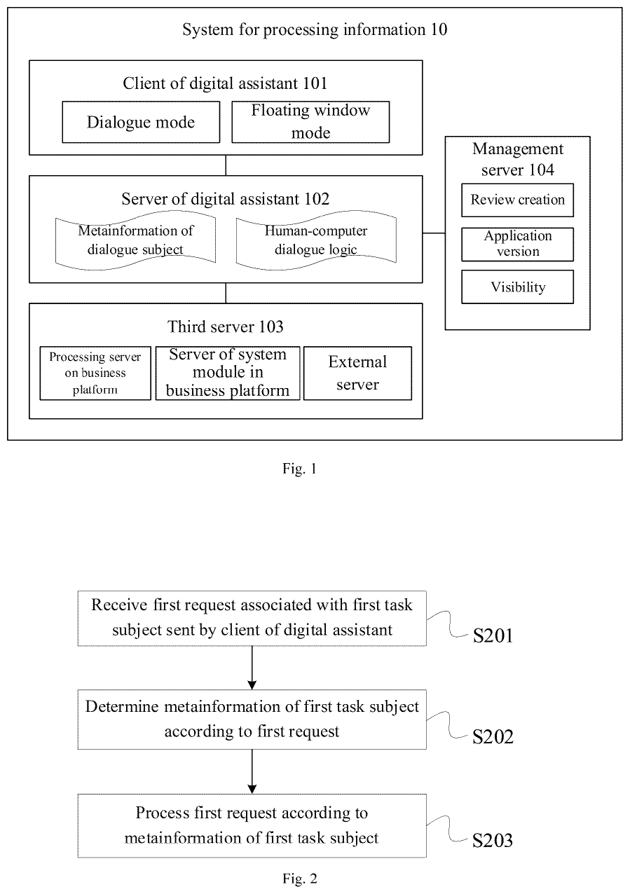

With reference to a schematic architecture diagram of a system for processing information shown in FIG. 1, the system for processing information 10 includes a client 101 of a digital assistant, a server 102 of the digital assistant, a third server 103, and a management server 104.

The client 101 of the digital assistant may perform human-computer dialogues with the server 102 of the digital assistant. In some embodiments, the digital assistant may be a standalone software system, and the client 101 of the digital assistant may perform human-computer dialogues with the standalone server 102 of the digital assistant. In some other embodiments, the digital assistant may also be deployed in other systems (e.g., a business platform), the digital assistant may provide a human-computer dialogue function in other systems as a system module, and the client 101 of the digital assistant may perform human-computer dialogues with the server 102 of a digital assistant module.

Specifically, the client 101 of the digital assistant may perform human-computer dialogues with the server 102 of the digital assistant in different modes. For example, the client 101 of the digital assistant may perform human-computer dialogues with the server 102 of the digital assistant in a dialogue mode, or in a floating window mode. The dialogue mode may indicate that human-computer dialogues are performed on a dialogue page provided by the server 102 of the digital assistant, and the floating window mode may indicate that in other system modules (e.g., a document module), human-computer dialogues are performed via a floating window component provided by the server 102 of the digital assistant.

The server 102 of the digital assistant may maintain human-computer dialogue logic. The human-computer dialogue logic may be understood as logic related to the interaction process of a human-computer dialogue, e.g., logic of providing a guide language to the client 101 of the digital assistant, logic of performing human-computer dialogues in the form of “ask and answer”, etc.

The server 102 of the digital assistant may provide a plurality of task subjects so that the client 101 of the digital assistant can perform human-computer dialogues under specific task subjects. In the embodiment of the present disclosure, the metainformation of the task subject is stored in the server 102 of the digital assistant, wherein the metainformation of the task subject may be understood as basic information related to attributes of the task subject. The server 102 of the digital assistant maintains the human-computer dialogue logic and stores the metainformation of the task subject, so that the server 102 of the digital assistant can realize functions related to the task subject, and when some task subjects involve changes in the human-computer dialogue logic, developers can make direct changes in the server 102 of the digital assistant, without involving other servers.

The third server 103 may be used to process request information of the client 101 of the digital assistant in the process of human-computer dialogues. Considering that the request information of the client 101 of the digital assistant is natural language content in the process of human-computer dialogues, the third server 103 may have natural language processing capabilities.

The specific logic of the third server 103 in processing the request information may be related to a creator of the task subject. Understandably, in the process of creating the task subject, the creator of the task subject may make a selection from natural language processing capability sets (e.g., language models for natural language processing, task subject-related plug-ins) provided by different third servers 103. As such, in the process of human-computer dialogues between the client 101 of the digital assistant and the server 102 of the digital assistant, the server 102 of the digital assistant may perform natural language processing with the help of the natural language processing capability of the selected third server 103, so that the third server 103 generates a reply message to finish the human-computer dialogue.

In some embodiments, the third server 103 may be a processing server on the business platform, and this processing server can be used to process natural language content. For example, when the server 102 of the digital assistant is deployed on the business platform, the business platform may provide natural language processing capability sets, and the creator of the task subject may make a selection from the natural language processing capability sets provided by the business platform. As such, in the process of human-computer dialogues, the server 102 of the digital assistant can utilize the processing server on the business platform to process natural language content.

In some other embodiments, the third server 103 may be a server of a system module in the business platform. Understandably, some system modules of the business platform may provide functions related to natural language processing, e.g., a document module may provide functions such as summarizing, optimizing, and translating document content. At this time, the system modules in the business platform may provide natural language processing capability sets, and the creator of the task subject may make a selection from the natural language processing capability sets provided by the system modules in the business platform. As such, in the process of human-computer dialogues, the server 102 of the digital assistant can utilize the servers of the system modules in the business platform to process natural language content.

In some other embodiments, the third server 103 may be an external server. A description is given with regard to an example in which the external server is an aPaaS (application platform as a service). The aPaaS may provide natural language processing capability sets, and the creator of the task subject may make a selection from the natural language processing capability sets provided by the aPaaS. As such, in the process of human-computer dialogues, the server 102 of the digital assistant can utilize the external server to process natural language content.

The management server 104 may be used to manage information related to human-computer dialogues under the task subject. For example, the management server 104 may review the creation of a new task subject. For another example, the management server 104 may manage a client version that provides the task subject. For another example, the management server 104 may manage the visibility (such as tenant visibility, sharing visibility, etc.) of subject dialogues.

The advantages of the architecture of the system for processing information according to the embodiment of the present disclosure are described below. In another architecture that is different from the system architecture according to the embodiment of the present disclosure, the metainformation of the task subject is stored in the management server. Since the metainformation of the task subject can be rapidly updated and iterated, the human-computer dialogue logic also changes frequently. And in this architecture, the human-computer dialogue logic is controlled by the server of the digital assistant and the metainformation of the task subject is stored in the management server, so when the metainformation of the task subject changes and the human-computer dialogue logic needs to be modified at the same time, developers who are responsible for the server of the digital assistant and developers who are responsible for managing the server need to carry out scheme design and code development jointly. However, in the architecture of the system for processing information according to the embodiment of the present disclosure, the server of the digital assistant not only controls the human-computer dialogue logic, but also stores the metainformation of the task subject, so when the metainformation of the task subject changes and the human-computer dialogue logic needs to be modified at the same time, only processing by the developers who are responsible for the server of the digital assistant is required, which brings lower development costs and higher efficiency.

In yet another architecture that is different from the system architecture according to the embodiment of the present disclosure, the metainformation of the task subject is stored in the processing server on the business platform. At this point, the processing flow that is involved in the human-computer dialogue between the client of the digital assistant and the server of the digital assistant may be controlled by the processing server on the business platform, and the server of the digital assistant may focus only on the interaction process with the client of the digital assistant (e.g., receiving the request information, sending the reply information, etc.), in this architecture, a universal agent protocol needs to be designed to adapt to different third servers, leading to higher development costs. Yet in the architecture of the system for processing information according to the embodiment of the present disclosure, the server of the digital assistant is used for performing human-computer dialogues with the client of the digital assistant, the third server is used for processing the request information in the process of human-computer dialogues, so decoupling the server of the digital assistant with the third server improves the architectural reasonability of the system for processing information.

With reference to a schematic flowchart of a method for processing information provided in the embodiment of the present disclosure shown in FIG. 2, the method may be applied to the server of the digital assistant, and the method specifically includes:
S201: receive a first request associated with a first task subject sent by a client of the digital assistant.

Task subject, also known as dialogue scene, may be understood as the subject or scene of a human-computer dialogue between the client of the digital assistant and the server of the digital assistant. The client of the digital server may select a task subject before starting dialogues, and through the selection of the task subject by the client of the digital assistant, the server of the digital assistant can perform targeted human-computer dialogues under the task subject selected by the user to improve the response accuracy.

The task subjects may be built in the server of the digital assistant, i.e. pre-configured by developers responsible for the server of the digital assistant, or may be created by a creator.

The process of creating a task subject in the embodiment of the present disclosure is described below by taking a first task subject as an example. The server of the digital assistant receives a creating request for the first task subject, extracts metainformation of the first task subject from the creating request, and creates the first task subject according to the metainformation of the first task subject and a sender of the creating request.

The sender of the creating request may be the client of the digital assistant or a second server, and the second server may be understood as an external third-party server. For example, in the embodiment of the present disclosure, the user who uses the digital assistant (i.e., the client of the digital assistant) and an external application (i.e., the third-party server) are supported to create the task subject. When the user of the digital assistant has the need for scene dialogues, the user can create the task subject by himself/herself to enrich scenes in which the user uses the digital assistant.

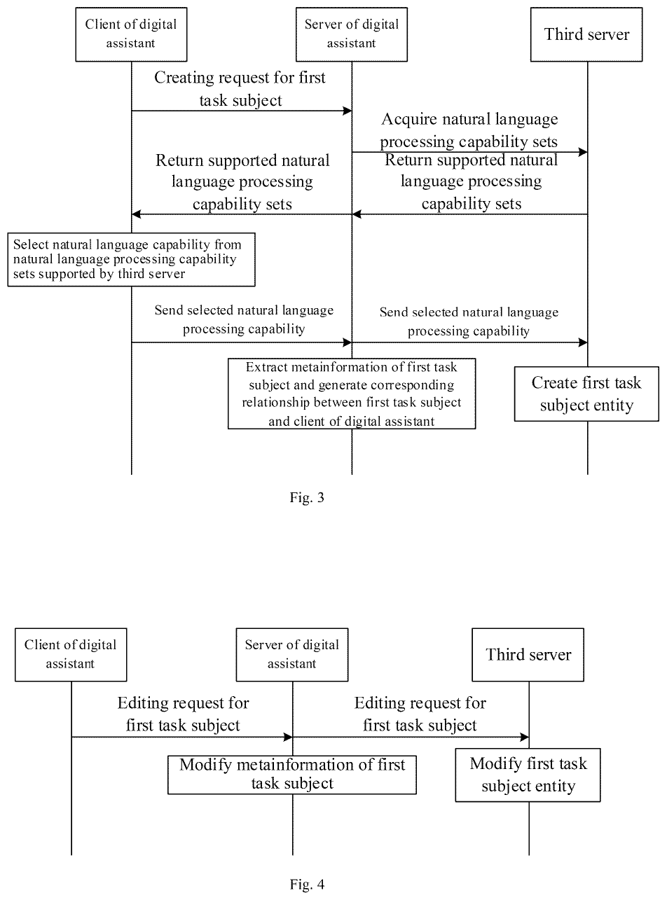

When the sender of the creating request is the client of the digital assistant, with reference to a schematic flowchart of creating a task subject shown in FIG. 3, the client of the digital assistant may trigger the creating request for the first task subject, and this creating request may carry information regarding the client of the digital assistant and information related to the first task subject (e.g., information of the third server used for processing the request information under the first task subject). When the server of the digital assistant is deployed on the business platform and the third server is the processing server on the business platform, the server of the digital assistant may acquire natural language processing capability sets from the third server and return the natural language processing capability sets to the client of the digital assistant for selection by the client of the digital assistant.

When the sender of the creating request is the third-party server, the third-party server may send the creating request for the first task subject by calling a creating interface of the server of the digital assistant, and this creating request may carry information regarding the third server and information related to the first task subject (e.g., information of the third server used for processing the request information under the first task subject).

In some embodiments, before extracting the metainformation of the first task subject, the server of the digital assistant may also authenticate the creating request for the first task subject. For example, the server of the digital assistant may authenticate the sender of the creating request, and determine whether the sender of the creating request has the permission to create the task subject.

Then, upon successful authentication, the server of the digital assistant may extract the metainformation of the first task subject. The metainformation of the first task subject may be understood as basic information related to attributes of the task subject, and in some possible implementations, the metainformation of the first task subject may include at least one selected from the group consisting of: identity (ID) information of the first task subject, type information of the task subject, and storage location information of the task subject. As such, the server of the digital assistant may generate a corresponding relationship between the first task subject and the sender of the creating request, indicating that the first task subject is created by the sender of the creating request of the first task subject. In addition, when the server of the digital assistant is deployed on the business platform and the third server is the processing server on the business platform, the third server may also create a first task subject entity, indicating the natural language capability of the third server used under the first task subject.

Further, upon completion of the creation of the first task subject, the creator of the first task subject may also edit the first task subject. During specific implementation, as shown in FIG. 4, the server of the digital assistant may receive an editing request for the first task subject sent by the creator of the first task subject, and modify the metainformation of the first task subject according to the editing request.

In addition, when the server of the digital assistant is deployed on the business platform and the third server is the processing server on the business platform, the server of the digital assistant may also send the editing request for the first task subject to the third server so that the third server modifies the first task subject entity.

In some possible implementations, before modifying the metainformation of the first task subject, the server of the digital assistant may also authenticate the editing request. For example, the server of the digital assistant may authenticate the first task subject, and determine whether editing for the first task subject is supported.

In addition, the creator of the first task subject may also disable the first task subject. During specific implementation, as shown in FIG. 5, the server of the digital assistant may receive a disabling request for the first task subject sent by the creator of the first task subject; and delete, according to the disabling request, the metainformation of the first task subject and a corresponding relationship between the first task subject and the client of the digital assistant using the first task subject.

In some embodiments, the server of the digital assistant may employ soft delete when deleting the metainformation of the first task subject. The soft delete may be understood as hiding, by means of some processing, the information that needs to be deleted, rather than actually deleting it from the database. For example, the database of the server of the digital assistant may include a field “Delete or Not”, and by modifying the value of the field corresponding to the metainformation of the first task subject to Yes, the metainformation of the first task subject is hidden in the database, so as to achieve the effect of soft delete.

In addition, when the server of the digital assistant is deployed on the business platform and the third server is the processing server on the business platform, the server of the digital assistant may also send the disabling request for the first task subject to the third server so that the third server deletes the first task subject entity.

In some possible implementations, before deleting the metainformation of the first task subject and the corresponding relationship between the first task subject and the client of the digital assistant using the first task subject, the server of the digital assistant may also authenticate the deleting request. For example, the server of the digital assistant may authenticate the sender of the deleting request, and determine whether the sender of the deleting request has the permission to delete the first task subject.

The first request associated with the first task subject may be understood as a request associated with the first task subject in a plurality of task subjects. For example, the first request may include a request for the client of the digital assistant to start a first session under the first task subject, a sharing request for the first task subject from the client of the digital assistant, an adding request for the first task subject from the client of the digital assistant, an information input request of the client of the digital assistant under the first task subject, etc.

S202: determine metainformation of the first task subject according to the first request.

In the embodiment of the present disclosure, the metainformation of the first task subject is stored in the server of the digital assistant, so after the first request associated with the first task subject is received by the server of the digital assistant, the metainformation of the first task subject can be rapidly determined such that subsequent processing with the metainformation of the first task subject can be facilitated.

S203: process the first request according to the metainformation of the first task subject.

Since the first request is associated with the first task subject, the server of the digital assistant may process the first request according to the metainformation of the first task subject, thereby realizing relevant functions under the first task subject.

For example, when the first request is a request for the client of the digital assistant to start the first session under the first task subject, the server of the digital assistant may bind the first task subject with the first session by processing the first request. For another example, when the first request is a sharing request for the first task subject from the client of the digital assistant, the server of the digital assistant may generate a link for sharing the task subject by processing the first request. For another example, when the first request is an adding request for the first task subject from the client of the digital assistant, the server of the digital assistant may realize addition of the first task subject into the second client of the digital assistant by processing the first request. For another example, when the first request is an information input request of the client of the digital assistant under the first task subject, the server of the digital assistant may return reply information by processing the first request.

Based on the above content description, the embodiment of the present disclosure provides a method for processing information. The method is applied to a server of a digital assistant. The server of the digital assistant receives a first request associated with a first task subject sent by a client of the digital assistant, and determines metainformation of the first task subject according to the first request, wherein the metainformation of the first task subject is stored in the server of the digital assistant. Then, the server of the digital assistant processes the first request according to the metainformation of the first task subject.

In this method, by storing the metainformation of the task subject in the server of the digital assistant, the server of the digital assistant is able to utilize the metainformation of the task subject for request processing when receiving a request associated with the task subject. As such, the server of the digital assistant can support task subject-related functions to realize the scene-based application of the digital assistant and further expand the application scene of the digital assistant.

For different first requests, the process of processing the first request by the server of the digital assistant is described in detail below.

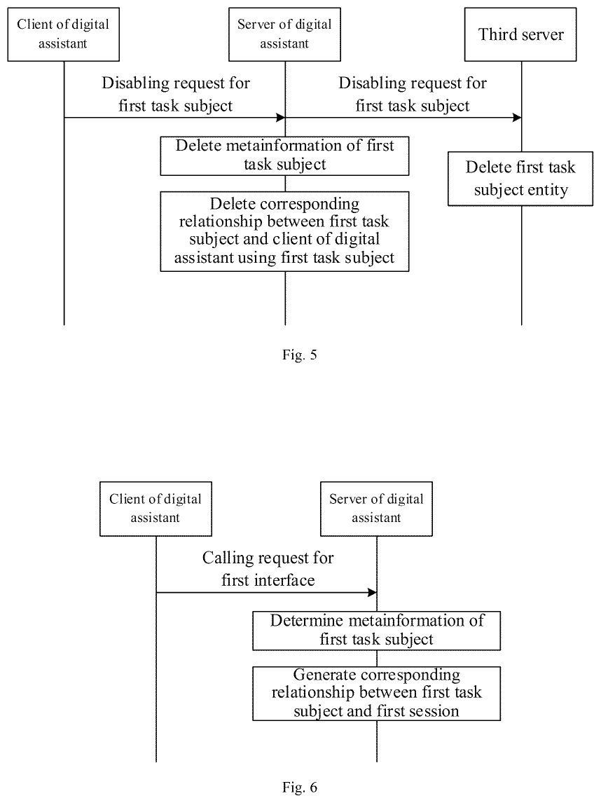

In some embodiments, the first request associated with the first task subject may be the request for the client of the digital assistant to start a session under the first task subject. During specific implementation, as shown in FIG. 6, the server of the digital assistant may receive a request for starting the first session under the first task subject, in response to a calling request for the first interface from the client of the digital assistant.

For example, when the client of the digital assistant wants to start a new session (also known as new topic), the client of the digital assistant may make a request by calling the first interface (e.g., newtopic interface), and carry the identity of the first task subject in the calling request for the first interface. As such, the server of the digital assistant may determine the metainformation of the first task subject through the identity of the first task subject.

Then, the server of the digital assistant may generate a corresponding relationship between the first task subject and the first session according to the metainformation of the first task subject. Understandably, when the client of the digital assistant starts a new session under the first task subject, the server of the digital assistant may bind the first task subject with the started first session, e.g., bind scene_id of the first task subject with session_id of the first session, so as to ascertain the task subject where the current session belongs. Since the client of the digital assistant requests to start the session by calling the first interface, there is no need for the client of the digital assistant to perceive information related to the first session, thereby saving the computing resources in the client of the digital assistant.

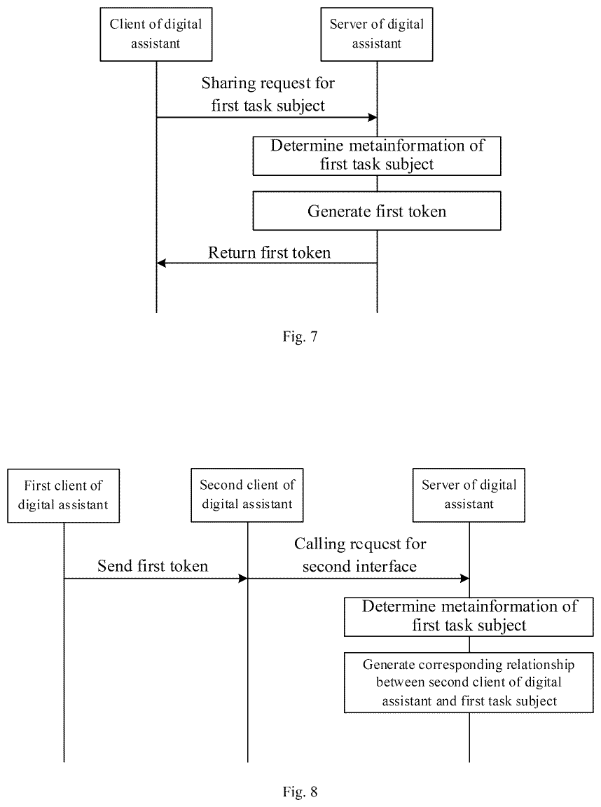

In some other embodiments, the first request associated with the first task subject may be a sharing request for the first task subject from the client of the digital assistant. As shown in FIG. 7, the client of the digital assistant may generate the sharing request for the first task subject, in response to a triggering operation for a sharing control. Understandably, the sharing request may carry the identity of the first task subject, and the server of the digital assistant may determine the metainformation of the first task subject through the identity of the first task subject.

Then, the server of the digital assistant may generate a first token according to the metainformation of the first task subject, and return the first token to the client of the digital assistant, wherein a link indicated by the first token may be used to add the first task subject.

For example, when the client of the digital assistant wants to share the first task subject with other clients, the server of the digital assistant may utilize, in response to the sharing request, the metainformation of the first task subject to generate the first token, so that the client of the digital assistant can send the first token to other clients to realize sharing of the task subject. As such, the client of the digital assistant has no need of generating the first token, saving the computing resources in the client of the digital assistant. Furthermore, the first token is generated only when the server of the digital assistant receives the sharing request, and by doing so, the storage resources in the client of the digital assistant are saved.

In some possible implementations, the first token may be generated based on a symmetric encryption and decryption algorithm, and the key for the symmetric encryption and decryption algorithm may be encrypted and stored in a distributed transaction framework. When the key needs to be used to decrypt the first token, the server of the digital assistant can obtain the key in real-time, thereby saving the storage costs in the server of the digital assistant.

In some embodiments, as shown in FIG. 8, the first client of the digital assistant sends the first token to the second client of the digital assistant, i.e., the first client of the digital assistant shares the first task subject to the second client of the digital assistant. The second client of the digital assistant may add the first task subject into the second client after receiving the first token sent by the first client of the digital assistant. At this moment, the server of the digital assistant may receive the adding request for the first task subject, in response to a calling request for a second interface from the second client of the digital assistant, wherein the calling request for the second interface may be generated by triggering the first token.

For example, when the second client of the digital assistant wants to add the first task subject, the second client of the digital assistant may trigger the first token, call the second interface of the server of the digital assistant, and send the adding request for the first task subject to the server of the digital assistant. Understandably, the adding request may carry the identity of the first task subject, and the server of the digital assistant may determine the metainformation of the first task subject through the identity of the first task subject.

Then, the server of the digital assistant may generate a corresponding relationship between the second client of the digital assistant and the first task subject according to the metainformation of the first task subject. As such, by generating, in the server of the digital assistant, the corresponding relationship between the second client and the first task subject so as to indicate inclusion of the first task subject in the task subject of the second client of the digital assistant, addition of the task subject is accomplished.

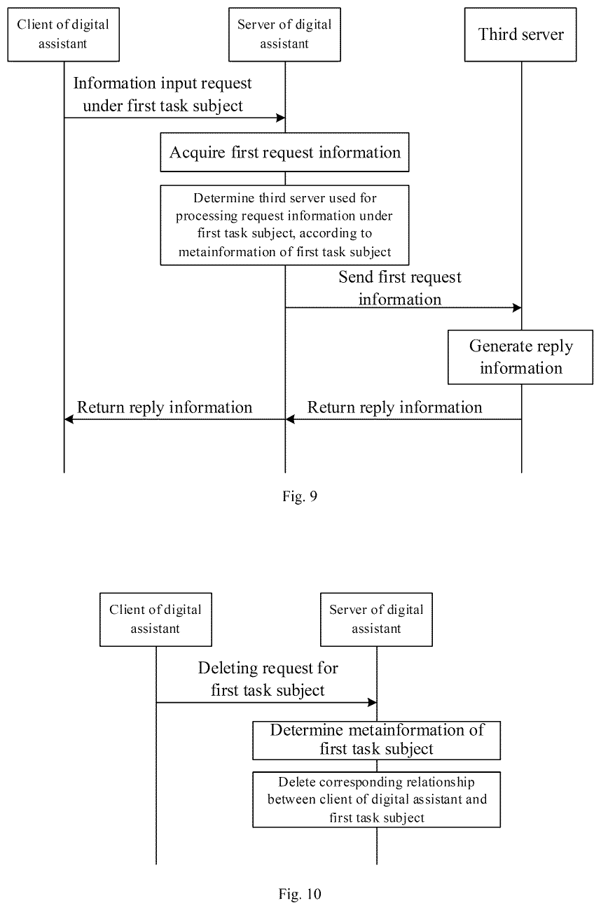

In some other embodiments, the first request associated with the first task subject may be the information input request of the client of the digital assistant under the first task subject. During specific implementation, as shown in FIG. 9, the server of the digital assistant may receive the information input request of the client of the digital assistant under the first task subject, and acquire the first request information sent by the client of the digital assistant.

For example, when the client of the digital assistant wants to send request information to the server of the digital assistant for purposes of human-computer dialogues, the server of the digital assistant may acquire first request information so that subsequent processing for the first request information can be facilitated. Understandably, the first request information is generally natural language content.

Then, the server of the digital assistant may determine, according to the metainformation of the first task subject, the third server used for processing the request information under the first task subject, send the first request information to the third server, receive reply information returned by the third server, and send the reply information to the client of the digital assistant.

The server used for processing the request information may differ under different task subjects. Therefore, the server of the digital assistant may determine the corresponding third server through the corresponding relationship according to the metainformation of the first task subject, so that the third server can process the first request information, e.g., the third server utilizes a language model to perform semantic recognition on the first request information and generates the reply information according to the result of semantic recognition. After the reply information is returned by the third server, the server of the digital assistant may send this reply information to the client of the digital assistant to complete reply to the first request information and realize human-computer dialogues.

In some other embodiments, the first request associated with the first task subject may be a deleting request for the first task subject from the client of the digital assistant. As shown in FIG. 10, understandably, the deleting request may carry the identity of the first task subject, and the server of the digital assistant may determine the metainformation of the first task subject through the identity of the first task subject.

Then, the server of the digital assistant may delete, according to the metainformation of the first task subject, the corresponding relationship between the client of the digital assistant and the first task subject. As such, by deleting the corresponding relationship, the first task subject is deleted from the task subjects of the client of the digital assistant.

In addition, the task subjects that are added by the client of the digital assistant may be displayed at this client, so that the client of the digital assistant can make a selection from the task subjects in order to start human-computer dialogues under specific task subjects. The embodiment of the present disclosure supports the server of the digital assistant to pull the task subjects in different ways. In some possible implementations, the server of the digital assistant may determine, based on the information of the client of the digital assistant (e.g., the identity of the client of the digital assistant), the task subjects (e.g., the identities of a plurality of task subjects) added by the client of the digital assistant, and acquire the task subjects in a sharding way based on the page size of the client of the digital assistant as well as the quantity of the task subjects acquired each time, thus realizing pulling of the task subjects.

In some other possible implementations, the server of the digital assistant may also resolve the identities of the task subjects through the token and then acquire the task subjects corresponding to the identities of the task subjects, thus realizing pulling of the task subjects. In addition, the server of the digital assistant may also directly utilize the identities of a plurality of task subjects to acquire the task subjects in batches, thus realizing batch pulling of the task subjects. This is not limited in the embodiment of the present disclosure.

The method for processing information provided in the embodiment of the present disclosure has been described above in detail with reference to FIG. 1 to FIG. 10, and a system and a device provided in the embodiments of the present disclosure are described below in conjunction with the accompanying drawings.

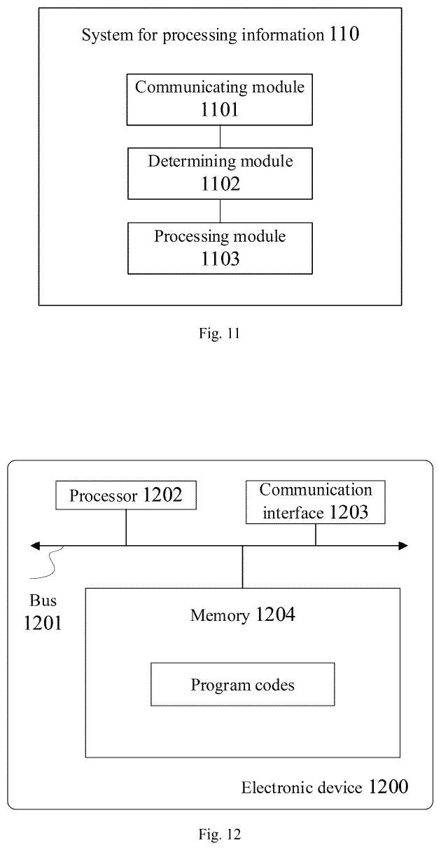

With reference to a schematic structure diagram of a system for processing information shown in FIG. 11, the system 110 includes: a communicating module 1101, a determining module 1102, and a processing module 1103.

The communicating module 1101 is configured to receive a first request associated with a first task subject sent by a client of a digital assistant.

The determining module 1102 is configured to determine metainformation of the first task subject according to the first request, wherein the metainformation of the first task subject is stored in a server of the digital assistant.

The processing module 1103 is configured to process the first request according to the metainformation of the first task subject.

In some possible implementations, the first task subject is created by the following steps of:
receiving a creating request for the first task subject, a sender of the creating request being the client of the digital assistant or a second server;
extracting the metainformation of the first task subject from the creating request; and
creating the first task subject according to the metainformation of the first task subject and the sender of the creating request.

In some possible implementations, the communicating module 1101 is further configured to:
receive an editing request for the first task subject sent by a creator of the first task subject;
the processing module 1103 is further configured to:
modify the metainformation of the first task subject according to the editing request.

In some possible implementations, the communicating module 1101 is further configured to:
receive a disabling request for the first task subject sent by a creator of the first task subject;
the processing module 1103 is further configured to:
delete, according to the disabling request, the metainformation of the first task subject and a corresponding relationship between the first task subject and the client of the digital assistant using the first task subject.

In some possible implementations, the communicating module 1101 is specifically configured to:
receive a request for starting a first session under the first task subject in response to a calling request of the client of the digital assistant for a first interface.

In some possible implementations, the first request associated with the first task subject sent by the client of the digital assistant includes a request for starting a first session under the first task subject, and the processing module 1103 is specifically configured to:
generate a corresponding relationship between the first task subject and the first session according to the metainformation of the first task subject.

In some possible implementations, the first request associated with the first task subject sent by the client of the digital assistant includes a sharing request for the first task subject, and the processing module 1103 is specifically configured to:
generate a first token according to the metainformation of the first task subject, in which a link indicated by the first token is used to add the first task subject; and
return the first token to the client of the digital assistant.

In some possible implementations, a second client of the digital assistant receives a first token sent by a first client of the digital assistant, a link indicated by the first token is used to add the first task subject, and the communicating module 1101 is specifically configured to:
receive an adding request for the first task subject in response to a calling request for a second interface from the second client of the digital assistant, in which the calling request for the second interface is generated by triggering the first toke;
the processing module 1103 is specifically configured to:
generate a corresponding relationship between the second client of the digital assistant and the first task subject according to the metainformation of the first task subject.

In some possible implementations, the communicating module 1101 is specifically configured to:
receive an information input request of the client of the digital assistant under the first task subject;
the system 110 further includes an acquiring module, and the acquiring module is configured to:
acquire first request information sent by the client of the digital assistant.

In some possible implementations, the first request associated with the first task subject sent by the client of the digital assistant includes an information input request of the client of the digital assistant under the first task subject, the information input request corresponds to the first request information, and the processing module 1103 is specifically configured to:
determine a third server according to the metainformation of the first task subject, in which the third server is used to process the request information under the first task subject;
send the first request information to the third server and receive reply information returned by the third server; and
send the reply information to the client of the digital assistant.

In some possible implementations, the first request associated with the first task subject sent by the client of the digital assistant includes a deleting request for the first task subject from the client of the digital assistant, and the processing module 1103 is specifically configured to:
delete a corresponding relationship between the client of the digital assistant and the first task subject according to the metainformation of the first task subject.

In some possible implementations, the metainformation of the first task subject includes at least one selected from the group consisting of: identity information of the first task subject, type information of the first task subject, and storage location information of the first task subject.

The system for processing information 110 according to the embodiment of the present disclosure may correspond to execution of the method described in the embodiment of the present disclosure, and the above and other operations and/or functions of various modules/units of the system for processing information 110 are respectively corresponding processes for realizing various methods in the embodiment shown in FIG. 2, and will not be repeated here for the sake of brevity.

Also provided in the embodiment of the present disclosure is an electronic device. The electronic device is specifically used to implement the functions of the system for processing information 110 in the embodiment as shown in FIG. 11.

FIG. 12 is a schematic structure diagram of an electronic device 1200 that includes, as shown in FIG. 12, a bus 1201, a processor 1202, a communication interface 1203, and a memory 1204. The processor 1202, the memory 1204 and the communication interface 1203 are communicated with each other via the bus 1201.

The bus 1201 may be a peripheral component interconnect (PCI) bus or an extended industry standard architecture (EISA) bus, etc. The bus may be divided into address bus, data bus, control bus, etc. For ease of representation, only one thick line is used in FIG. 12, but it does not mean that there is only one bus or one type of buses.

The processor 1202 may be any one or more of processors such as central processing unit (CPU), graphics processing unit (GPU), micro processor (MP), or digital signal processor (DSP).

The communication interface 1203 is used for external communication. For example, the communication interface 1203 may be used to communicate with a terminal.

The memory 1204 may include volatile memory, such as random access memory (RAM). The memory 1204 may also include nonvolatile memory, such as read-only memory (ROM), flash memory, hard disk drive (HDD), or solid state drive (SSD).

Executable codes are stored in the memory 1204 and are executed by the processor 1202 to execute the aforementioned method for processing information.

Specifically, in the case that the embodiment shown in FIG. 11 is implemented and in the case that various modules or units of the system for processing information 110 described in the embodiment of FIG. 11 are implemented via software, software or program codes required to perform the functions of various modules/units in FIG. 11 may be partially or wholly stored in the memory 1204. The processor 1202 executes the program codes corresponding to various units stored in the memory 1204, to execute the aforementioned method for processing information.

Also provided in the embodiment of the present disclosure is a computer readable storage medium. The computer readable storage medium may be any usable medium capable of being stored by a computing device, or a data storage device such as a data center containing one or more usable media. The usable medium may be magnetic medium (e.g., floppy disk, hard disk, magnetic tape), optical medium (e.g., DVD), or semiconductor medium (e.g., solid-state drive), etc. The computer readable storage medium includes instructions that instruct a computing device to perform the above method for processing information applied to the system for processing information 110.

Also provided in the embodiment of the present disclosure is a computer program product including one or more computer instructions. When the computer instructions are loaded and executed on a computing device, processes or functions according to the embodiments of the present disclosure are produced, in whole or in part.

The computer instructions may be stored in a computer readable storage medium, or transmitted from one computer readable storage medium to another computer readable storage medium, e.g., the computer instructions may be transmitted from one website site, computer or data center to another website site, computer or data center in a wired (such as coaxial cable, optical fiber, digital subscriber line (DSL)) or wireless (such as infrared, wireless, microwave, etc.) way.

When the computer program product is executed by a computer, the computer performs any of the aforesaid method for processing information. This computer program product may be a software installation package, and in a case where any of the aforesaid method for processing information needs to be used, this computer program product may be downloaded and executed on the computer.

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that various embodiments in this specification are described in a progressive manner, description of each embodiment focuses on its differences from other embodiments, and for the same and similar parts among various embodiments, reference is made mutually. With regard to the system or apparatus disclosed in the embodiment, it has been described in a relatively simple way due to its correspondence to the method disclosed in the embodiment, and for the relevant system or apparatus parts, reference may be made to the method parts.

It should be understood that in the present disclosure, “at least one” refers to one or more, and “a plurality of” refers to two or more. “and/or” is used to describe the association relationship of associated objects, indicating that there may be three relationships, e.g., “A and/or B” may indicate that there are three cases: only A, only B, and both A and B, where A and B may be singular or plural. The character “/” generally indicates that the relationship between the previous and next associated objects is “or”. “At least one selected from the group consisting of . . . ” or similar expression thereof means any combination of these items, including single item or any combination of plural items. For example, at least one selected from the group consisting of a, b, or c, may indicate: a, b, c, “a and b”, “a and c”, “b and c”, or “a and b and c”, where a, b, c may be single or multiple.

It should also be noted that in this specification, relational terms such as first and second, etc., are used solely to distinguish one entity or operation from another, and do not necessarily require or imply any such actual relationship or sequence between those entities or operations. Further, the term “including”, “containing” or any other variation thereof is intended to cover nonexclusive inclusion, so that a process, method, article or device that includes a series of elements includes not only those elements, but also other elements that are not expressly listed, or elements that are inherent to such process, method, article or device. In the absence of further restrictions, elements defined by the statement “including one . . . ” do not preclude the existence of additional identical elements in the process, method, article or device that includes said elements.

The steps of the method or algorithm described with reference to the embodiments disclosed herein may be implemented directly in hardware, software modules executed by a processor, or a combination of both. The software modules may be placed in random access memory (RAM), memory, read-only memory (ROM), electrically programmable ROM, electrically erasable programmable ROM, register, hard disk, removable disk, CD-ROM, or any other form of storage medium known in the technical field.

The foregoing description of the disclosed embodiments enables those skilled in the art to realize or use the present disclosure. Various modifications to these embodiments will be apparent to those skilled in the art, and the general principles defined herein may be realized in other embodiments without departing from the spirit or scope of the present disclosure. Accordingly, the present disclosure will not be limited to these embodiments shown herein, but will conform to the broadest range consistent with the principles and novel features disclosed herein.

1. A method for processing information, applied to a server of a digital assistant, comprising:
receiving a first request associated with a first task subject sent by a client of the digital assistant;
determining metainformation of the first task subject according to the first request, wherein the metainformation of the first task subject is stored in the server of the digital assistant; and
processing the first request according to the metainformation of the first task subject.

2. The method according to claim 1, wherein the first task subject is created by steps comprising:
receiving a creating request for the first task subject, wherein a sender of the creating request is the client of the digital assistant or a second server;
extracting the metainformation of the first task subject from the creating request; and
creating the first task subject according to the metainformation of the first task subject and the sender of the creating request.

3. The method according to claim 2, further comprising:
receiving an editing request for the first task subject sent by a creator of the first task subject; and
modifying the metainformation of the first task subject according to the editing request.

4. The method according to claim 2, further comprising:
receiving a disabling request for the first task subject sent by a creator of the first task subject; and
deleting, according to the disabling request, the metainformation of the first task subject and a corresponding relationship between the first task subject and the client of the digital assistant using the first task subject.

5. The method according to claim 1, wherein the receiving a first request associated with a first task subject sent by a client of the digital assistant comprises:
receiving a request for starting a first session under the first task subject in response to a calling request of the client of the digital assistant for a first interface.

6. The method according to claim 1, wherein the first request associated with the first task subject sent by the client of the digital assistant comprises a request for starting a first session under the first task subject, and the processing the first request according to the metainformation of the first task subject comprises:
generating a corresponding relationship between the first task subject and the first session according to the metainformation of the first task subject.

7. The method according to claim 1, wherein the first request associated with the first task subject sent by the client of the digital assistant comprises a sharing request for the first task subject, and the processing the first request according to the metainformation of the first task subject comprises:
generating a first token according to the metainformation of the first task subject, wherein a link indicated by the first token is used to add the first task subject; and
returning the first token to the client of the digital assistant.

8. The method according to claim 1, wherein a second client of the digital assistant receives a first token sent by a first client of the digital assistant, a link indicated by the first token is used to add the first task subject, and
the receiving the first request associated with the first task subject sent by the client of the digital assistant comprises:
receiving an adding request for the first task subject in response to a calling request for a second interface from the second client of the digital assistant, wherein the calling request for the second interface is generated by triggering the first token; and
the processing the first request according to the metainformation of the first task subject comprises:
generating a corresponding relationship between the second client of the digital assistant and the first task subject according to the metainformation of the first task subject.

9. The method according to claim 1, wherein the receiving the first request associated with the first task subject sent by the client of the digital assistant comprises:
receiving an information input request of the client of the digital assistant under the first task subject.

10. The method according to claim 1, further comprising:
acquiring first request information sent by the client of the digital assistant.

11. The method according to claim 1, wherein the first request associated with the first task subject sent by the client of the digital assistant comprises an information input request of the client of the digital assistant under the first task subject, the information input request corresponds to the first request information, and the processing the first request according to the metainformation of the first task subject comprises:
determining a third server according to the metainformation of the first task subject, wherein the third server is used to process the request information under the first task subject;
sending the first request information to the third server and receiving reply information returned by the third server; and
sending the reply information to the client of the digital assistant.

12. The method according to claim 1, wherein the first request associated with the first task subject sent by the client of the digital assistant comprises a deleting request for the first task subject from the client of the digital assistant, and the processing the first request according to the metainformation of the first task subject comprises:
deleting a corresponding relationship between the client of the digital assistant and the first task subject according to the metainformation of the first task subject.

13. The method according to claim 1, wherein the metainformation of the first task subject comprises at least one selected from the group consisting of: identity information of the first task subject, type information of the first task subject, and storage location information of the first task subject.

14. A non-transitory computer readable storage medium, comprising instructions, wherein the instructions are executed by an electronic device to implement a method for processing information, and the method comprises:
receiving a first request associated with a first task subject sent by a client of the digital assistant;
determining metainformation of the first task subject according to the first request, wherein the metainformation of the first task subject is stored in the server of the digital assistant; and
processing the first request according to the metainformation of the first task subject.

15. An electronic device, comprising at one processor and at one memory,
wherein the processor is configured to execute instructions stored in the memory, enabling the electronic device to execute a method for processing information, and the method comprises:
receiving a first request associated with a first task subject sent by a client of the digital assistant;
determining metainformation of the first task subject according to the first request, wherein the metainformation of the first task subject is stored in the server of the digital assistant; and
processing the first request according to the metainformation of the first task subject.

16. The electronic device according to claim 15, wherein the first task subject is created steps comprising:
receiving a creating request for the first task subject, wherein a sender of the creating request is the client of the digital assistant or a second server;
extracting the metainformation of the first task subject from the creating request; and
creating the first task subject according to the metainformation of the first task subject and the sender of the creating request.

17. The electronic device according to claim 16, wherein the method further comprises:
receiving an editing request for the first task subject sent by a creator of the first task subject; and
modifying the metainformation of the first task subject according to the editing request.

18. The electronic device according to claim 16, wherein the method further comprises:
receiving a disabling request for the first task subject sent by a creator of the first task subject; and
deleting, according to the disabling request, the metainformation of the first task subject and a corresponding relationship between the first task subject and the client of the digital assistant using the first task subject.

19. The electronic device according to claim 15, wherein the receiving a first request associated with a first task subject sent by a client of the digital assistant comprises:
receiving a request for starting a first session under the first task subject in response to a calling request of the client of the digital assistant for a first interface.

20. The electronic device according to claim 15, wherein the first request associated with the first task subject sent by the client of the digital assistant comprises a request for starting a first session under the first task subject, and the processing the first request according to the metainformation of the first task subject comprises:
generating a corresponding relationship between the first task subject and the first session according to the metainformation of the first task subject.
